(19) United States
(12) Patent Application Publication
(10) Pub. No.: US 2019/0032399 A1
(43) Pub. Date: Jan. 31, 2019

(54) Adjustable-Width Safety Gate Covers

(71) Applicant: Better Options, LLC, Milton, GA (US)

(72) Inventor: Janelle Fitzpatrick, Milton, GA (US)

(73) Assignee: Better Options, LLC, Milton, GA (US)

(21) Appl. No.: 15/724,274

(22) Filed: Oct. 4, 2017

Related U.S. Application Data
(63) Continuation-in-part of application No. PCT/US2016/014746, filed on Jan. 25, 2016.
Application No. PCT/US2016/014746 is a continuation of application No. 14/860,674, filed on Sep. 21, 2015, now Pat. No. 9,567,797.
(60) Provisional application No. 62/403,710, filed on Oct. 4, 2016.

(51) Int. Cl. E06B 9/02; E06B 9/06; E06B 9/00

(52) U.S. Cl. CPC E06B 9/02; E06B 9/0692; Y10T 24/2561; Y10T 16/558; E06B 2009/002

(57) ABSTRACT

An adjustable-width cover for removable installation on a safety gate, the safety gate having a width defined by opposed end posts and a height defined by top and bottom support rods, the cover includes a flexible, frameless, planar, and generally-rectangular cover member, the vertical height of the cover member is less than the safety gate, the width of the cover member is greater than the width of the safety gate and covers the front side of the safety gate and at least a portion of the back side of the safety gate when installed. The cover is maintained in tension using a plurality of adjustable length straps extending from each side edge of the cover on the back side of the safety gate. A motion sensor, with an adjustable sensitivity level, is used to detect motion and provide notification when the cover is moved, climbed on, or otherwise disturbed.

### CROSS-REFERENCE TO RELATED APPLICATIONS

This patent application claims priority benefit under 35 U.S.C. § 119(e) to U.S. Prov. Pat. Appl. No. 62/403,710, entitled “Adjustable-Width Safety Gate Covers,” filed Oct. 4, 2016, and is a continuation-in-part of and claims priority benefit under 35 U.S.C. § 120 to PCT Int'l Patent Application No. PCT/US2016/014746, entitled “Adjustable-Width Flexible Stair Barrier,” filed Jan. 25, 2016, which is a continuation of and claims priority benefit under 35 U.S.C. § 120 to U.S. patent application Ser. No. 14/860,674, entitled “Adjustable-Width Flexible Stair Barrier,” filed Sep. 21, 2015 (now U.S. Pat. No. 9,567,797). All of the above-referenced patents and applications are hereby incorporated by reference, in their entirety, as if set forth in full herein.

### FIELD OF THE PRESENT TECHNOLOGY

The present invention relates generally to stairwell barriers and passageway safety gates and, more particularly, to aesthetically-pleasing safety gate covers that are capable of being used with safety gates with a wide range of widths and from a wide variety of manufacturers.

### BACKGROUND OF THE PRESENT TECHNOLOGY

Most conventional child safety gates are constructed with an inflexible outer frame structure having rigid horizontal and vertical members to support the rigid, structural integrity of such frame. Since safety is the primary concern and purpose of such child safety gates, ease of installation, potential damage caused to walls, banisters, and railings, and aesthetic appearance are all secondary considerations that are often sacrificed. Conventional rigid-framed gates are often difficult to install and equally difficult to disassemble and remove or relocate. Furthermore, conventional rigid-framed gates require drilling into the walls and wooden banisters, or in the alternative, require tedious assembly of clumsy wooden or plastic faceplates that are then hinged to the existing stairway rails as a means of attaching the safety gate. Furthermore, conventional rigid-framed child safety gates are not easily installed or used at the bottom of stairwells—particularly stairwells having custom decorative stairway posts, banisters, or balusters, which typically have vertically varying diameters and configurations, are non-parallel relative to each other, are non-perpendicular relative to flooring surface or are otherwise asymmetrical, or are very wide (i.e., horizontally-spaced apart at the bottom of the stairs). Typical child safety gates often leave large gaps between the safety gate and the stairway railing in which a small child may become trapped or wedged while attempting to wiggle through such a gap.

Although conventional gates may be somewhat satisfactory in preventing the ingress and egress of small children and pets through doorways and onto stairway passages, particularly at the top of a stairway, Applicant has experienced great success and market appeals for its adjustable-width stairwell barriers that have a planar, frameless, horizontally-flexible but vertically-rigid barrier that can be easily, securely, and removably installed at the bottom of any one of a plurality of stairwells having a wide range of possible widths and intended to prevent children and pets from going up the stairs. Demand has been high for Applicant's barriers not only because of their functionality, ease of use, and minimal damage to walls and banisters, but also because Applicant's barriers are visually attractive and aesthetically pleasing—particularly in modern, elegant homes having high-end, custom stairway posts, spindles, balusters, and banisters.

With most existing and conventional (e.g., compression or fixedly-mounted) safety gates on the market designed specifically for the top of a stairwell, within a doorway, or across a passageway, Applicant has focused on providing barriers that are designed primarily for use at the bottom of stairwells in banister-to-banister or wall-to-banister configurations.

However, with the success of Applicant's bottom of the stairwell barricades, a strong desire has emerged in the market for Applicant to provide aesthetically-pleasing sleeves or covers that can be used with existing and conventional safety gates with a wide range of designs, including widths, and from a wide range of manufacturers. Specifically, there is a need in the market for gate owners to improve the aesthetic appearance of conventional safety gates without interfering with their usability or safety functionality. In addition, there is a strong desire in the market from existing owners of Applicant's bottom of the stairwell barricades to be able to match the style and appearance of their conventional safety gates with the superior appearance of their bottom of the stairwell barricades.

Furthermore, there is a need for an adjustable-width cover or wrap for conventional safety gates that can be customized in style and appearance and that has the practical attribute of being washable, easy to remove, and easy to transport or carry to different locations.

Yet further, there is a need for a safety gate or safety gate cover that includes an incorporated motion sensor or motion detector that is capable of transmitting a warning notification to an application or device used by a parent or other owner of the safety gate or safety gate cover when the safety gate or safety gate cover has been moved or disturbed after being installed in a close configuration. A threshold level for such motion can be set so that notifications are only sent to the parent or other owner of the safety gate or safety gate cover when the safety gate or safety gate cover has been moved or disturbed above the threshold level. Such threshold level prevents notifications from being sent too often or when there is only a minor touching or movement of the safety gate or cover, while enabling notifications to be sent when there has been a more significant opening, a climbing event, or potential collapse of the safety gate or cover.

The present invention provides a non-obvious solution to all of the above problems and challenges.

Further advantages of the methods and systems described herein will become apparent to one of skill in the art after reviewing the remainder of the present application with reference to the drawings and detailed description which follows.

### SUMMARY OF THE PRESENT TECHNOLOGY

The present invention relates generally to stairwell barriers and passageway safety gates and, more particularly, to aesthetically-pleasing safety gate covers that are capable of being used with safety gates with a wide range of widths and from a wide variety of manufacturers.

In a first aspect of the present invention, an adjustable-width cover for removable installation on a safety gate is disclosed. The safety gate has a width defined by opposed end posts and has a predetermined height defined by a top support rod and a bottom support rod. The safety gate has a front side and a back side. The cover include a flexible, frameless, planar, and generally-rectangular cover member having a fixed vertical height extending between a top edge and a bottom edge and a fixed width extending between opposed side edges, wherein the fixed vertical height of the cover member is less than the predetermined height of the safety gate and wherein the fixed width of the cover member is greater than the width of the safety gate, the cover member having a main portion extending the width of the safety gate and end portions on either side of the main portion that extend a predetermined distance beyond each of the opposed end posts of the safety gate; and a plurality of fasteners vertically spaced along the fixed vertical height of the cover member, each of the plurality of fasteners having a pair of straps, distal ends of each of the pair of straps configured to engage each other in releasable locking manner, wherein one of the pair of straps extends from one of the opposed side edges of the cover member and the other of the pair of straps extends from the other of the opposed side edges of the cover member, wherein at least one of the pair of straps has an adjustable length; wherein the main portion of the cover member is positioned on the front side of the safety gate and wherein the end portions of the cover member wrap around each of the opposed end posts of the safety gate and are positioned on a portion of the back side of the safety gate, wherein, when the distal ends of each of the pair of straps are engaged with each other in releasable locking manner on the back side of the safety gate, the cover member is maintained in tension along both the front side and back side of the safety gate by tightening the adjustable length of each of the plurality of fasteners.

In a feature, the cover does not interfere with mechanical or moving portions of the safety gate.

In another feature, the top edge of the cover is releasably connected to the top support rod of the safety gate. Preferably, the top edge of the cover is releasably connected to the top support rod of the safety gate using one or more ties, straps, or buckles.

In a further feature, the bottom edge of the cover is releasably connected to the bottom support rod of the safety gate. Preferably, the bottom edge of the cover is releasably connected to the bottom support rod of the safety gate using one or more ties, straps, or buckles.

Typically, when the distal ends of each of the pair of straps are engaged with each other in releasable locking manner on the back side of the safety gate, the cover member does not fully cover the back side of the safety gate, which leaves a gap between each of the opposed side edges of the cover member. Preferably, the cover further includes a gap member that is sized to cover the gap between each of the opposed side edges of the cover member.

In another feature, the cover further includes a motion sensor. In some embodiments, the motion sensor includes an audible alarm. In other embodiments, the motion sensor transmits a notification signal using a wireless communication protocol. In yet further embodiments, the motion sensor does both.

Preferably, the motion sensor detects motion of the cover above a predetermined threshold. In some embodiments, the predetermined threshold establishes a sensitivity level of the motion sensor and, in some embodiments, the sensitivity level is adjusted mechanically on the motion sensor. In other embodiments, the sensitivity level is adjusted electronically using an application running on a remote computing device that communicates electronically with the motion sensor.

The above features as well as additional features and aspects of the present invention are disclosed herein and will become apparent from the following description of preferred embodiments of the present invention.

### BRIEF DESCRIPTION OF THE DRAWINGS

The foregoing summary, as well as the following detailed description of illustrative embodiments, and the present invention, as defined in the claims, can be better understood with reference to the following drawings. For the purpose of illustrating the embodiments, there is shown in the drawings example constructions of the embodiments; however, the embodiments are not limited to the specific methods and instrumentalities disclosed. The components within the drawings are not necessarily drawn to scale relative to each other. On the contrary, the dimensions of the various features are arbitrarily expanded or reduced for clarity, emphasis instead being placed upon clearly illustrating the principles of the present invention. In addition, further features and benefits of the present technology will be apparent from a detailed description of preferred embodiments thereof taken in conjunction with the following drawings, wherein similar elements are referred to with similar reference numbers, and wherein:

FIGS. 1-13 illustrate Applicant's bottom of the stairwell, banister-to-banister and wall-to-banister barricades. FIGS. 14-16 are specifically drawn to Applicant's adjustable-width safety gate cover or wrap.

FIG. 1 illustrates a perspective view of an improved adjustable-width stairwell barricade according to the present invention;

FIG. 2 illustrates a front, plan view of the improved adjustable-width stairwell barricade shown in FIG. 1;

FIG. 3 illustrates a rear, plan view of the improved adjustable-width stairwell barricade shown in FIG. 1;

FIG. 4 illustrates a front view of the improved adjustable-width stairwell barricade shown in FIG. 1 with the lateral, internal structural support shown in dashed lines;

FIG. 5 illustrates a front view of the improved adjustable-width stairwell barricade shown in FIG. 1 with the vertical, internal structural support shown in dotted lines;

FIG. 6 illustrates a cutaway, perspective view of vertical supports illustrated in FIG. 5;

FIG. 7 illustrates a perspective view of an alternate installation of the improved adjustable-width stairwell barricade of FIG. 1;

FIG. 8 illustrates a perspective view of another alternate installation of the improved adjustable-width stairwell barricade of FIG. 1;

FIG. 9 illustrates a perspective view of a second embodiment of an improved adjustable-width stairwell barricade according to the present invention;

FIGS. 10-11 illustrate close-up perspective views of portions of the improved adjustable-width stairwell barricade of FIG. 9;

FIGS. 12-13 illustrate perspective views of the improved adjustable-width stairwell barricade of FIGS. 1 and 9, respectively, when installed in a stowed position;

FIG. 14 illustrates a front view of a safety gate cover or wrap, positioned in front of, but not yet installed around the safety gate;

FIG. 15 illustrates a back view of a safety gate cover or wrap, positioned in front of, but not yet installed around, the safety gate; and

FIG. 16 illustrates a back view of the safety gate cover or wrap, positioned in front of and installed around the safety gate.

### DETAILED DESCRIPTION OF PREFERRED EMBODIMENTS

Although the invention has been described in terms of exemplary embodiments, the invention is not intended to be limited to the specific terminology so selected. Rather, it is to be understood that the appended claims should be construed broadly, to include all technical equivalents that operate in a similar manner to accomplish similar functions.

The preceding merely illustrates the principles of the invention. It will thus be appreciated that those skilled in the art will be able to devise various arrangements that, although not explicitly described or shown herein, embody the principles of the invention and are included within its spirit and scope. Furthermore, all examples and conditional language recited herein are primarily intended only to aid the reader in understanding the principles of the invention and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

As used in the specification and the appended claims, the singular forms “a,” “an” and “the” include plural referents unless the context clearly dictates otherwise. Similarly, “optional” or “optionally” means that the subsequently described event or circumstance may or may not occur, and the description includes instances in which the event or circumstance occurs and instances where it does not.

Throughout the description and claims of this specification, the word “comprise” and variations of the word, such as “comprising” and “comprises,” mean “including but not limited to,” and is not intended to exclude, for example, other components, integers, elements, features, or steps. “Exemplary” means “an example of” and is not necessarily intended to convey an indication of preferred or ideal embodiments. “Such as” is not used in a restrictive sense, but for explanatory purposes only.

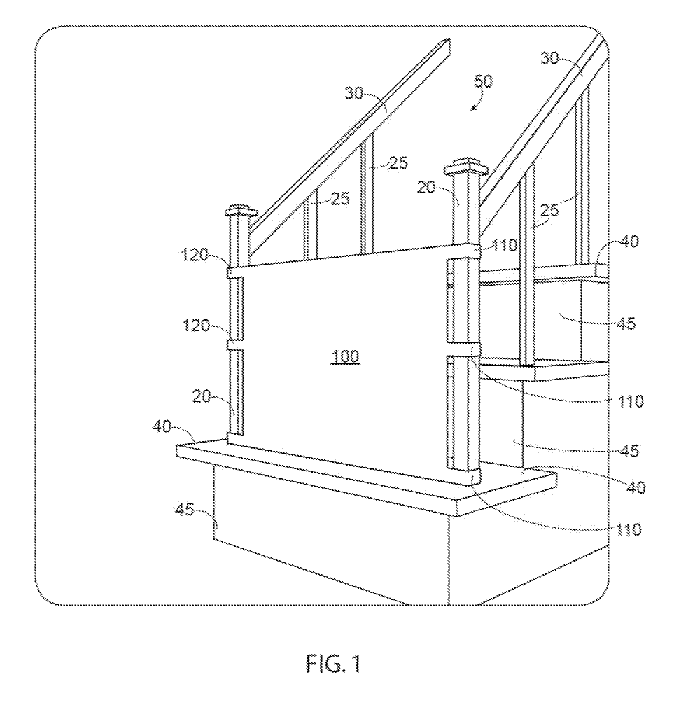

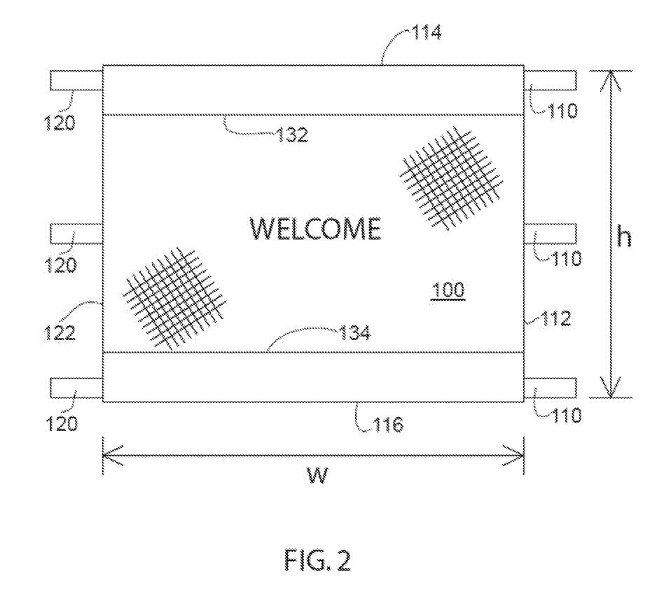

Referring now to FIG. 1, a perspective view of one exemplary adjustable-width barrier or gate member 100 removably installed between opposed banisters 20 of a stairwell or staircase 50 is illustrated. A typical stairwell or staircase 50 includes banisters 20, spindles or balusters 25, hand rails 30 (if the staircase is open on both sides; and/or a wall rail (not shown) if the staircase has a wall on one or both sides and the rail is mounted directly to the wall rather than on the spindles/balusters 25), and stairs. The stairs are generally made up of a plurality of treads or steps 40 and risers 45.

As used herein, a banister 20 is generally used to describe the larger, usually more-decorative post at the bottom (or top) of the staircase that provides substantial support to one end of the hand rail 30. The spindles or balusters 25 generally describe the plurality of less-decorative posts, usually between the banister 20 at the bottom of the stairwell and the banister at the top of the stairs (not shown), which provide some support along the length of the hand rail 30 and provide some safety benefits along the open side(s) of the staircase. The term “banister” can also be used to describe the entire hand rail system that includes the handrail, each banister post, and all of the spindles. For this reason, the term “post” or “post of a banister” will be used generally herein to refer to any of the banisters, spindles, or balusters associated with a hand rail used in a stair case or stairwell. Each post has a vertical height that is defined as the distance extending from the location at which the post intersects with or extends out of the bottom surface of the hand rail 30 to the location at which the base of the post is mounted to or intersects with the surface of the stair tread 40 or the floor. For purposes of this disclosure and the appended claims, the floor is deemed to be the bottommost step or tread 40.

Typically, if the staircase is open on both sides, each post under one hand rail will have a corresponding post disposed at the same symmetrical location under the other hand rail. Each pair of corresponding posts will be disposed a horizontal distance across the stairwell from each other, although the distance may vary from one pair of posts to the next—particularly at the bottom of higher-end staircases in which the posts and hand rails tend to flair out further apart than the posts along the main and upper portions of the staircase. If the staircase has a wall on one side, each post under the hand rail side of the stair case will be disposed a horizontal distance from the wall and, usually, a slightly lesser distance at the bottom of the post relative to the stairwell molding.

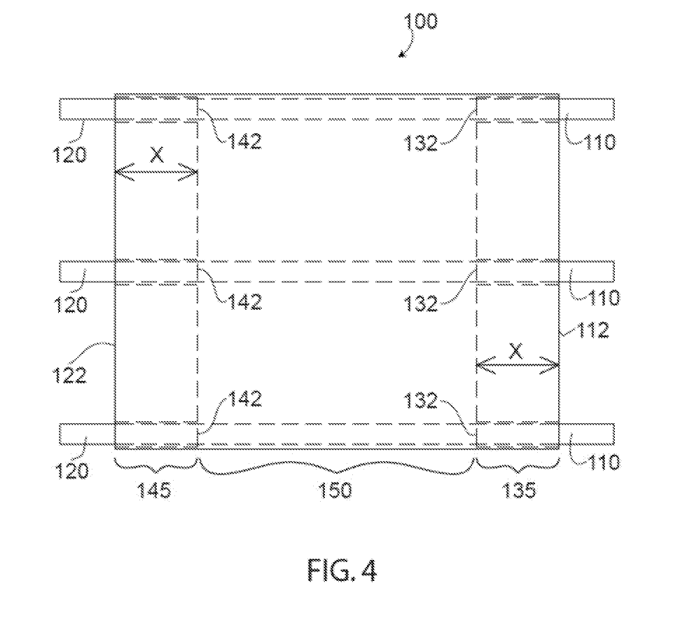

Referring now to FIGS. 1-3, the adjustable-width barrier 100 is preferably a planar, frameless, flexible, and generally-rectangular gate member having a width w extending between each side edge 112, 114 of the gate member and a height h extending between a top edge 114 and a bottom edge 116 of the gate member, the width w, when fully expanded, being substantially equal to or greater than the horizontal distance between the respective posts to which the barrier 100 is mounted, installed, or otherwise attached. The height h of the barrier 100 is substantially equal to or less than the vertical height of the respective posts, or at least the height of the posts below the intersection of the posts with the hand rails 30, if the posts extend above the hand rails 30, as shown by the posts 20 in FIG. 1.

A first plurality of fasteners 110 are vertically spaced along and extending from one side edge 112 of the gate member 100, each fastener having two straps adapted to engage in locking manner around one of the posts. A second plurality of fasteners 120 are vertically spaced along and extending from the other side edge 122 of the gate member 100, each fastener having two straps adapted to engage in locking manner around the corresponding post on the opposite side of the stairwell.

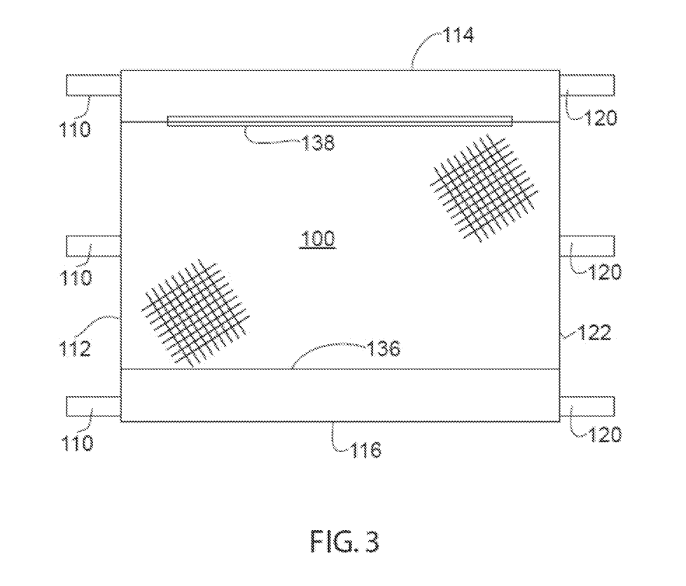

The adjustable-width barrier 100 is preferably made or fabricated out of a durable resilient material, such as lightweight meshed netting and reinforced nylon, with an attractive, washable woven cloth or woven fabric used as the material for the exterior surface of the adjustable-width barrier 100. The attractive washable woven cloth or woven fabric, used as the material for the exterior surface, can be of various aesthetically pleasing, decorative, ornamental designs and colors. As shown in FIG. 2, custom words (e.g., “Welcome”) or a design (e.g., team athletic logo) can be prominently displayed on one or both sides of the barrier 100. In addition, stitching 132, 134, 136 can be used both for aesthetic and structural reinforcement purposes. On the back side of the barrier 100, a slot 138 provides access to the interior of the barrier between the front and back surfaces of the barrier 100. The slot 138 can be closed with a zipper or Velcro type fastener. As will be described in greater detail hereinafter, access to the interior enables insertion or removal of a plurality of struts that, when inserted within channels running vertically along the inside of the barrier, provide vertical rigidity along the height of the barrier 100.

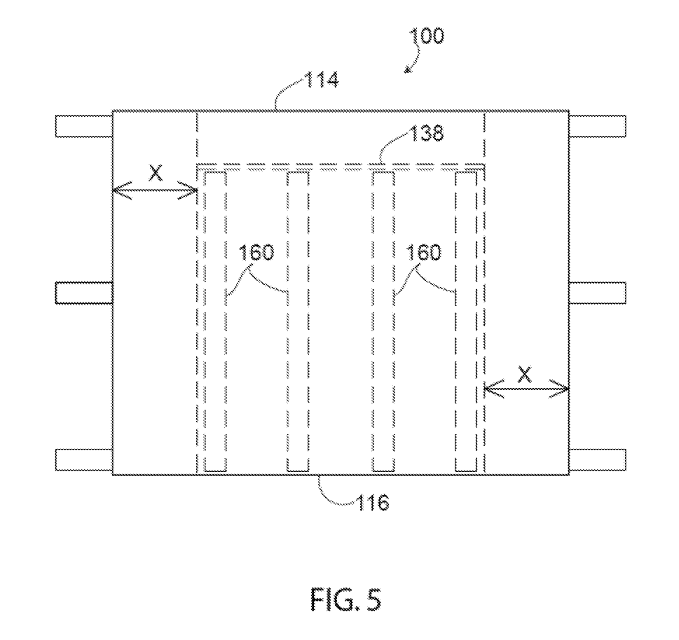

Turning now to FIG. 4, the lateral or horizontal structural support for the barrier 100 is described. Specifically, the configuration of the first and second plurality of fasteners 110, 120 is illustrated and described hereinafter. Preferably, each of the plurality of fasteners includes two mating straps extending away from a respective edge 112, 122 of the barrier 100, the two mating straps being configured to fasten, engage, or connect with each other after being wrapped and tightened around one of the respective posts of the stairwell. Preferably, the length of at least one of the straps is adjustable to provide lateral tension to the barrier 100.

In a preferred embodiment, the fasteners are side-release, three-point buckles; however, the fasteners can be one of many different types within the scope of the invention including, but not limited to, loop type fasteners, snap type fasteners, hook and eye type fasteners, and the like. Preferably, one of the mating straps is connected (e.g., stitched) to the edge 112, 122 of the barrier 100. The other mating strap is preferably connected (e.g., stitched) a fixed distance x within the interior of the barrier 100. The connection location is designated generally by stitch lines 132, 142. Furthermore, the other mating strap of fastener 110 is not connected to the interior of the barrier 100 between the stitch line 132 and the edge of the barrier 112, which defines a cinch or selectively-compressible portion 135 of the barrier. Similarly, the other mating strap of fastener 120, on the other side of the barrier 100, is not connected to the interior of the barrier 100 between the stitch line 142 and the edge of the barrier 122, which defines a cinch or selectively-compressible portion 145 of the barrier. To provide structural integrity and lateral tension across the barrier 100, the other mating strap of fastener 110 is connected with the other mating strap of fastener 120 and connected (e.g., stitched) substantially, continuously between stitch lines 132 and 142, which define the main body portion 150 of the barrier 100. Because the length of the other mating straps, which are stitched at connections points 132, 142 and which extend out from each side of the barrier 100, are adjustable, the barrier 100 is able to be tightened around the posts 20 so that the middle portion 150 of the barrier 100 remains taut when the mating straps are adjusted and tightened appropriately. The two side portions 135 and 145 of the barrier 100 are able to contract, cinch, or compress, as necessary, which enables the barrier 100 to be installed between posts 20 that are spaced apart a distance that is less than the width w of the barrier 100.

Preferably, the mating strap of each of the first plurality of fasteners 110 extending from one side edge 112 of the barrier 100 is connected with a corresponding mating strap of the second plurality of fasteners 120 disposed at the same vertical location and extending from the other side edge 122 of the barrier 100. The connected mating straps each define an adjustable length strap that extends laterally within the interior of the barrier 100. The plurality of fasteners 110, 120 include, at a minimum, an upper fastener that is located inside and just below the top edge 114 of the barrier and a lower fastener that is located inside and just above the bottom edge 116 of the barrier 100. Preferably, the fasteners also include one or two middle fasteners disposed between the upper and lower fasteners. Because each fastener can be independently tightened and adjusted for length, the barrier 100 is able to be installed snugly and tightly onto most any type of post or combination of posts, including decorative or ornate posts 20 that have different shapes or circumferences at different points along the height of such posts.

Preferably, a portion of each respective fastener includes a surface for non-slip and/or non-damaging engagement with the respective post of the stairwell.

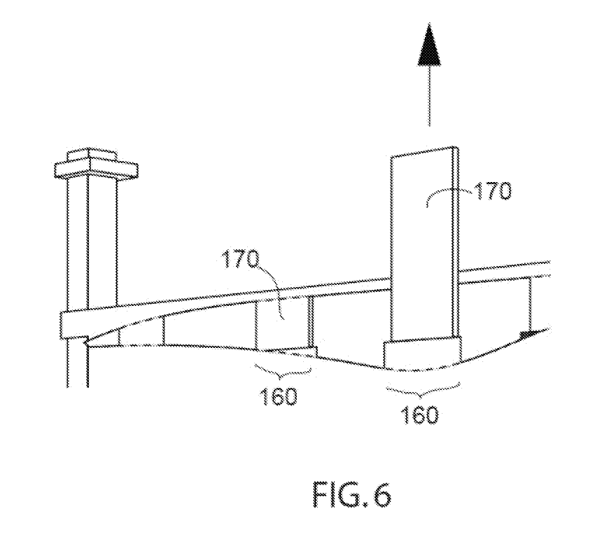

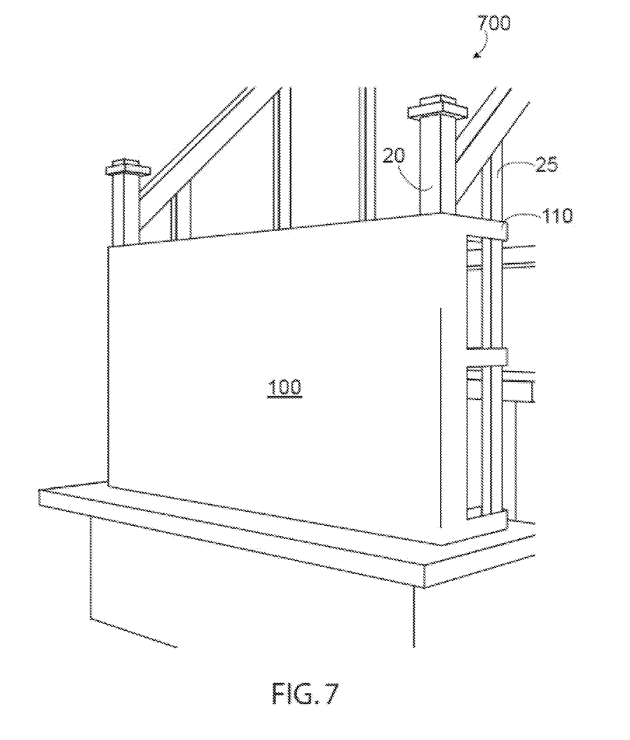

Turning now to FIGS. 5 and 6, the longitudinal or vertical structural support for the barrier 100 is described. Specifically, a plurality of vertical channels 160 extend generally between the top edge 114 and the bottom edge 116 of the barrier 100. Each of the vertical channels 160 are transversely spaced along the width of the barrier 100. Preferably, the vertical channels 160 only extend up to the slot 138 on the back side of the barrier 100. As stated previously, the slot 138 provides access to the interior between the front and back surfaces of the barrier 100. A rigid support bar or strut 170 is inserted into the top opening of each vertical channel 160, whereby the plurality of struts 170 act as structural vertical support members for the entire barrier 100. Although each vertical channel 160 only extends between the slot 138 and the bottom edge 116 of the barrier, each strut 170 preferably extends fully between the top edge 114 and the bottom edge 116 of the barrier 100. Preferably, there are two or more vertical channels 160 that extend relatively equidistantly from each edge of the barrier and from each other—with the number of vertical channel being determined based on the width of the barrier 100. In this manner, the height of the barrier 100 is rigidly maintained in non-compressible form across the entire width of the barrier 100.

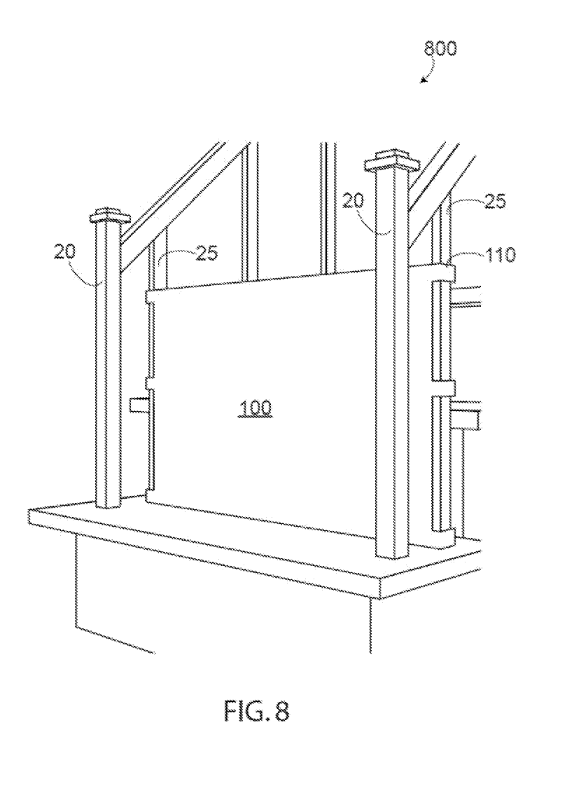

Turning now to FIG. 7, an alternate installation 700 of the barrier 100 is illustrated. In contrast with the installation of the barrier 100 shown in FIG. 1, in which the fasteners 110, 120 are wrapped solely around the banisters 20, the alternate installation 700 illustrates that the main body of the barrier 100 can wrap around the banisters 20 but then the fasteners 110, 120 are engaged with the spindles or balusters 25.

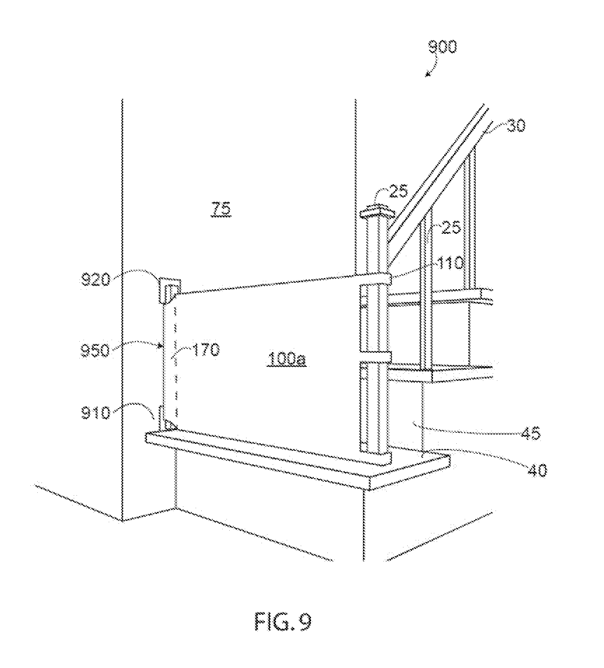

Turning now to FIG. 8, yet another alternate installation 800 of the barrier 100 is illustrated. In contrast with the installation of the barrier 700 shown in FIG. 7, in which it is shown that the main body of the barrier 100 can be wrapped first around the banisters 20 and then attached by engaging the fasteners 110, 120 around the spindles or balusters 25, the alternate installation 800 illustrates that the fasteners 110, 120 can be wrapped solely around a pair of spindles or balusters 25 without engaging the larger posts or banisters 20.

The various installation options shown in FIGS. 1, 7, and 8 illustrate that the adjustable-width barrier 100 disclosed herein can have a wide range of widths and can be installed across stairwells of varying widths and structural designs, shapes, and styles as well.

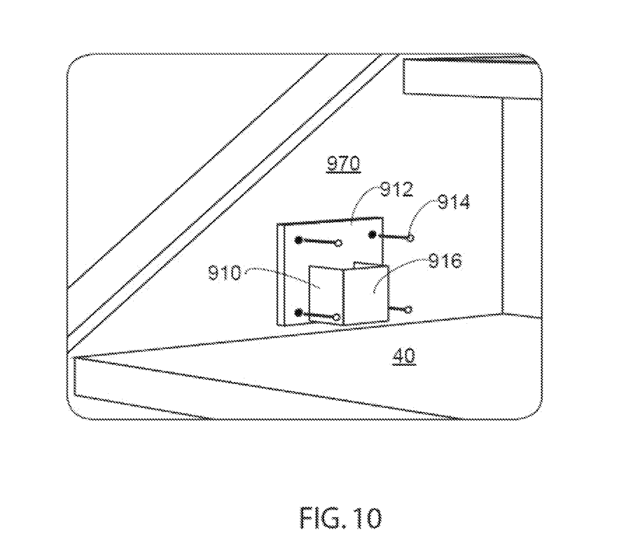

FIGS. 9-11 illustrate yet a further embodiment of the present invention in which the adjustable-width barrier 100a is installed between a banister 20 and a wall 75, in a wall-to-banister configuration. As with the embodiments shown in FIGS. 7 and 8, the adjustable width barrier 100a could be wrapped around the banister 20 and then connected using fasteners 110 to a spindle/baluster 25 or could be connected directly to the spindle/baluster 25 without wrapping around the banister 20.

In contrast with the adjustable-width barrier 100 illustrated in FIGS. 1-8, which included a second plurality of fasteners 120, the adjustable-width barrier 100a has an interior channel 170 through which a rod 930 is inserted. The rod 930 is part of a wall-mounting kit 950 that also includes a bottom support bracket 910 and a top support bracket 920. With this embodiment, the adjustable-width barrier 100a is mounted onto the rod 930, but the width and lateral tension maintained across the barrier 100a is controlled by the plurality of fasteners 110 as mounted on the relevant post(s) 20, 25. Although not shown, it will be understood by those of skilled in the art that the adjustable-width barrier 100, having a second set of fasteners 120, could also be used in conjunction with the wall mounting kit 950, rather than using the adjustable-width barrier 100a with the interior channel 170. In such an arrangement, the second set of fasteners would be installed around the rod 930 in the same manner as they would be installed around one or more posts 20, 25.

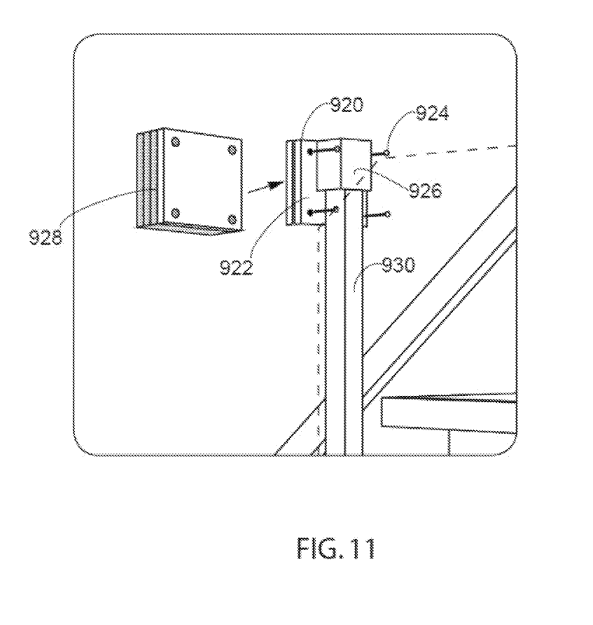

The bottom support bracket 910 is preferably mounted onto the stairwell molding 970 just above the floor or stair tread 40, as shown in FIG. 10. The bottom support bracket 910 includes a face plate 912 that is mounted to the stairwell molding 970 in conventional manner using screws or nails 914. The bottom support bracket 910 also includes a rod cap 916 for receiving one end of the rod 930.

The top support bracket 920 is preferably mounted onto wall 75 perpendicularly relative to the floor of stair tread 40, as shown in FIG. 11. The top support bracket 920 includes a face plate 922 that is mounted to the wall 75 in conventional manner using screws or nails 924. One to four spacer plates 928 may be inserted between the face plate 922 and the wall 75 to the extent necessary to match the thickness of the stairwell molding 970. The top support bracket 920 also includes a rod cap 926 for receiving the other end of the rod 930.

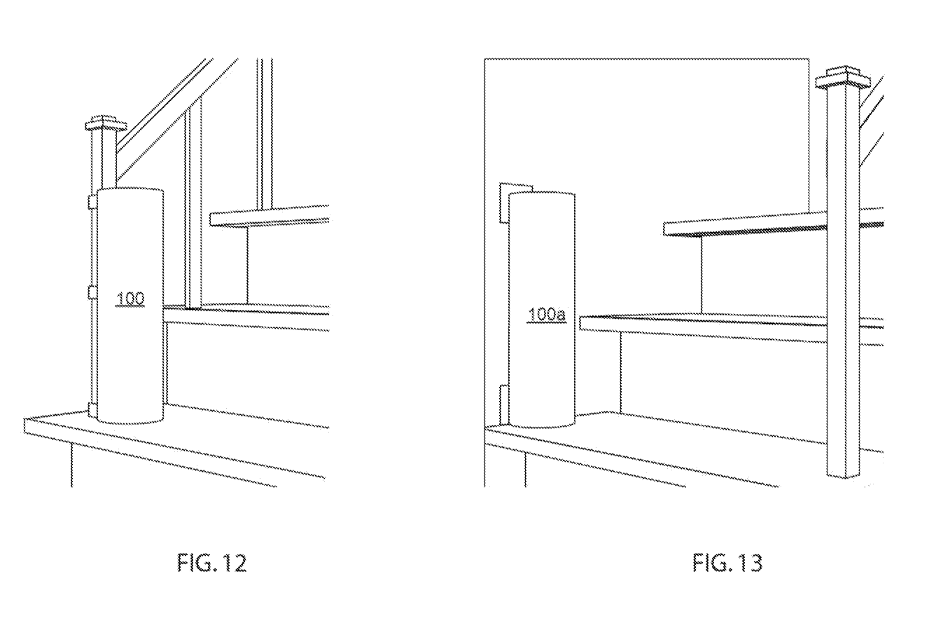

Turning now to FIGS. 12 and 13, it is shown that the adjustable-width barriers 100, 100a can be rolled up to one side or the other when not in use across the stairwell. The fasteners 110, 120 enable the adjustable-width barrier to roll easily and compactly to one side of the stairwell or the other. In the meantime, the struts 170 enable the adjustable-width barrier to maintain its vertical rigidity and form even when in the rolled-up position.

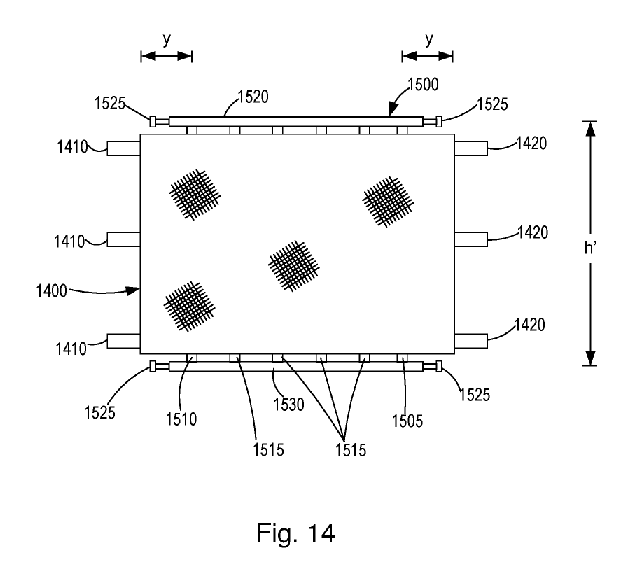

Turning now to FIGS. 14-16, an adjustable-width safety gate cover or wrap 1400 is illustrated. The cover 1400 is aesthetically-pleasing and suitable for use with a wide range of conventional safety gates 1500, as are typically used at the top of stairwells or across doorways, hallways, and other passageways.

In preferred embodiments, the adjustable-width safety gate cover or wrap 1400 is intended to be sized to fit a safety gate 1500 of pre-determined height h′, but is capable of being adjusted, to some extent, in width in a manner similar to the above-mentioned banister-to-banister and wall-to-banister barricade design. As shown, safety gate 1500 is a simple design—without having multiple panels and without having an interior, pivotable gateway. It will be appreciated by those of skill in the art that the cover or wrap 1400, described herein, can be used with simple safety gates, as shown, or with more complicated safety gates merely by selecting the appropriate end posts around which the wrap or cover 1400 is installed to avoid interference with any mechanical or moveable portions of the safety gate. The safety gate 1500 has a top support rod 1520 and a bottom support rod 1530. A plurality of spaced, vertical posts 1505, 1510, 1515 extend between the top support rod 1520 and the bottom support rod 1530. The safety gate 1500 is typically designed to be mounted between two flat wall surfaces or door jams. As shown, a set of four compression mounts 1525 extend from each end of the top support rod 1520 and the bottom support rod 1530. The compression mounts 1525 adjust in and out of the top support rod 1520 and the bottom support rod 1530 in conventional manner.

The wrap 1400 covers the front side of the conventional safety gate 1500, as shown in FIG. 14, and extends some distance y beyond the effective side or intended wrap edge of the safety gate 1500. As shown in FIG. 14, the wrap 1400 is not yet installed—it is in position to be installed around the safety gate 1500. In this case, the effective edge or intended wrap edge of the safety gate 1500 is defined by the end bars or posts 1505, 1510 of the gate. Several adjustable-length belt straps 1410, 1420 extend from each edge of the wrap 1400. Each strap 1410 on one side edge of the wrap are intended to engage in mating connection with a corresponding, respective strap 1420 on the other side edge of the wrap. In preferred embodiments, the mating connections are three-point harness connectors; however, any suitable connector may be used—similar to the adjustable straps described above with respect to the bannister barricade. Preferably, the straps are adjustable length and can be tightened as needed.

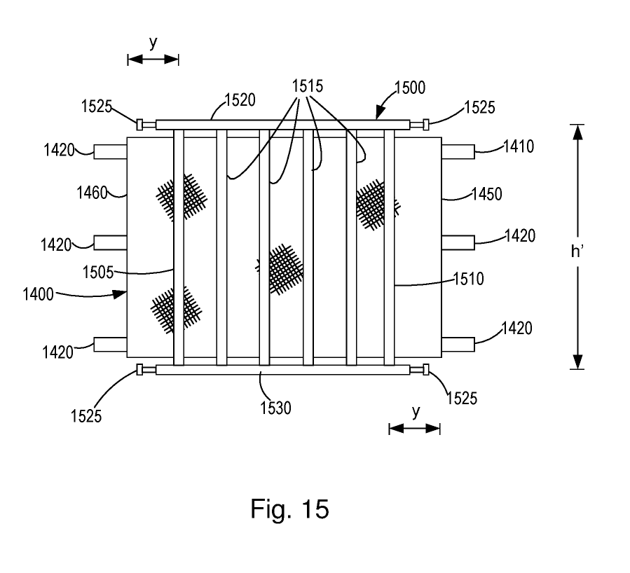

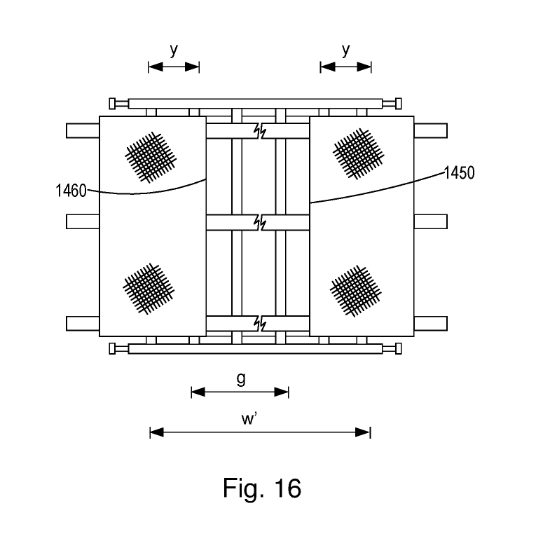

FIG. 15 illustrates the wrap 1400 from the back side of the safety gate 1500. Still, the wrap 1400 is shown in uninstalled position around the safety gate 1500. FIG. 16 illustrates the wrap 1400 after it has been installed and tightened around the safety gate 1500. It is expected that there will be some distance or gap g between each side edge 1450, 1460 of the wrap on the back side of the gate, even after the wrap has been tightened in place with the adjustable length belt straps. The wrap is preferably positioned on the safety gate extending between top support rod 1520 and the bottom support rod 1530 of the safety gate. The wrap may be flush with one or both of the support rods 1520, 1530 or there may be some slight spacing therebetween. As stated previously, the wrap is positioned on the safety gate without interfering with any hinge or latch portion of the gate—in other words, the wrap is not intended to prevent opening, closing, or swinging of any mechanical or moveable portions of the safety gate 1500, but only to cover the non-moving, main portion of the safety gate. Thus, for safety gates that have a swinging door above a bottom support beam, the wrap preferably just extends to the bottom of the swinging gate and not all the way to the bottom support to avoid interfering with the normal function of the gate. Separate wraps (not shown) can be used to cover side panels or extension panels for gates that are used for wide expanses. The wrap also preferably does not extend over the top bar or support rod of the gate—this minimizes the risk of interfering with any mechanical latches.

When tightened, the adjustable length belt straps 1410,1420 preferably provide enough lateral tension from the wrap to remain in place around the “gate” portion of the safety gate in both the horizontal and vertical directions. Some elasticity can be included in the vertical direction of the wrap to enable it to be used with gates of slightly varying heights—allowing the wrap to be stretched to full height when necessary or cinched slightly to reduce its height for smaller height gates. Optionally, one or more ties or straps (not shown) may be included along the top and bottom edges of the wrap to enable the wrap to be tied to the top and/or bottom support rods 1520,1530 of the gate. Such ties or straps, while unnecessary in most embodiments, are useful for maintaining the distance or height of the wrap when installed. Obviously, in contrast with the stand-alone barricades described above, there is no need for the gate wrap 1400 to have vertical struts to maintain the vertical integrity of the wrap since the underlying gate 1500 performs and provides that safety functionality.

The wrap preferably includes a separate and optional back cover (not shown) that is used to hide the space or gap g (and the horizontal tightening straps 1410,1420) on the back side of the safety gate. The back cover is designed to be the same height as the front panel of the wrap, with a width that extends at least beyond the width of the gap g, but not wider than the width w′ of the safety gate being covered. Any type of connectors can be used to attach the back cover to the portions of the wrap that extend around to the back side of the safety gate. Preferably, Velcro or magnets are used as connectors between the front and back panels to accommodate the potential range of safety gate widths. However, tie straps, button, snaps, and zippers can all be used as well.

As far as somewhat similar products known in the industry, Applicant is aware of the following two references, which are representative of known art:

Whooley, U.S. Pat. No. 9,267,323, discloses and describes a cover designed solely to improve the aesthetic appearance of a conventional safety gate. Basically, this patent teaches use of a front and back panel that is designed to wrap completely around the non-mechanical portions of the safety gate. The back cover includes a top flap, a bottom flap, and two side flaps that wrap around the frame of the safety gate and snap, tie, Velcro, etc. to the from cover. The cover can either be “wrapped” completely around the gate before it has been installed or it can be partially snapped together on 2-3 sides and then “slipped over” the main portion of the safety gate.

The Whooley patent assumes that the cover is sized to fit a specific gate dimensions. Elastic bands can be inserted to enable the cover to stretch to fit a slightly wider or taller gate. The cover can be bunched slightly to fit a smaller sized gate. It is not designed to be fitted tightly using adjustable straps. In addition, Whooley requires that the cover wrap, at least, over the top bar of the safety gate.

Silverman, US Publ. Appl. No. 2011/0296666, is not directed to a safety gate cover, but is representative of the numerous decorative door covers described in the art. Silverman discloses a fabric sheet, similar in shape to a mattress cover, that includes several adjustable-length belt straps with 3-point snap connectors that extend both horizontally and vertically on the back side of the door to pull the cover taut on the front side of the door. Like Whooley, Silverman covers all four side edges of the door. Unlike Whooley, Silverman does not include a back cover.

In preferred embodiments, a motion sensor or detector (not shown) is preferably installed on an outer surface of or embedded within the planar barricades illustrated in FIGS. 1-13 or on an outer surface of or embedded within the adjustable-width safety gate cover or wrap illustrated in FIGS. 14-16.

In some embodiments, such motion sensor or detector has an audible alarm that is triggered when the barricade or cover is disturbed. Preferably, the motion detector or sensor has an on/off switch to enable an adult to keep the sensor/detector off when the barricade or cover is being initially installed or when an adult is opening or removing the barricade or cover. Preferably, the on/off switch is positioned and configured so as to be “child-proof” to prevent a child from being able to disable the sensor intentionally or accidentally.

In some embodiments, the sensor or detector has a Bluetooth or wireless transmitter to enable the sensor or detector to transmit a notification signal to an application installed on a device of a parent or other owner of the barricade or cover. Such notification signal can be used separately or in conjunction with the above-described audible alarm. The notification signal enables a parent or other owner of the barricade or cover to be notified whenever motion has been detected whether the parent or other owner is located in close proximity to the barricade or cover (for example, when the parent or owner is within the house) or even if the parent or other owner is located remotely (for example, when the parent or owner has left the house).

Preferably, the motion sensor or detector is configurable to have a minimum threshold motion level to adjust the sensitivity of the motion detector or sensor. The motion detector or sensor can be set to maximum sensitivity to detect a motion and trigger an alarm or notification if there is even slight or minimal movement. At a medium setting, the sensitivity of the motion detector or sensor can be set to trigger an alarm or notification signal only if there has been significant movement of the barricade or cover—such as may occur if a child or dog jumps on, climbs on, or runs into the barricade or cover. At the furthest extreme, the sensitivity of the motion detector or sensor can be set to trigger an alarm or notification signal only if the barricade or cover has actually fallen or been dramatically disturbed.

Preferably, the sensitivity level can be set mechanically on the motion sensor or detector. Alternatively, the sensitivity level can be set electronically using the application installed on the device of the parent or other owner of the barricade or cover that receives the notification signal and notifies the device user that motion has been detected above the threshold motion level desired by the user.

This description of the exemplary embodiments is intended to be read in connection with the figures of the accompanying drawing, which are to be considered part of the entire written description. In the description, relative terms such as “lower,” “upper,” “horizontal,” “vertical,” “above,” “below,” “up,” “down,” “top,” and “bottom” as well as derivatives thereof (e.g., “horizontally,” “downwardly,” “upwardly,” etc.) should be construed to refer to the orientation as then described or as shown in the drawing under discussion. These relative terms are for convenience of description and do not require that the apparatus be constructed or operated in a particular orientation. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

The above-described preferred embodiments are intended to illustrate the principles of the invention, but not to limit its scope thereto. The described preferred embodiments are not intended to be exhaustive or to limit the invention to the precise form disclosed. Rather, the appended claims should be construed broadly, to include other variants and embodiments of the invention, which will be apparent to those skilled in the art and may be made without fundamentally deviating from the spirit and scope of the invention, as illustrated in the above-described preferred embodiments.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. An adjustable-width cover for removable installation on a safety gate, the safety gate having a width defined by opposed end posts and having a predetermined height defined by a top support rod and a bottom support rod, the safety gate having a front side and a back side, comprising:
a flexible, frameless, planar, and generally-rectangular cover member having a fixed vertical height extending between a top edge and a bottom edge and a fixed width extending between opposed side edges, wherein the fixed vertical height of the cover member is less than the predetermined height of the safety gate and wherein the fixed width of the cover member is greater than the width of the safety gate, the cover member having a main portion extending the width of the safety gate and end portions on either side of the main portion that extend a predetermined distance beyond each of the opposed end posts of the safety gate; and
a plurality of fasteners vertically spaced along the fixed vertical height of the cover member, each of the plurality of fasteners having a pair of straps, distal ends of each of the pair of straps configured to engage each other in releasable locking manner, wherein one of the pair of straps extends from one of the opposed side edges of the cover member and the other of the pair of straps extends from the other of the opposed side edges of the cover member, wherein at least one of the pair of straps has an adjustable length;
wherein the main portion of the cover member is positioned on the front side of the safety gate and wherein the end portions of the cover member wrap around each of the opposed end posts of the safety gate and are positioned on a portion of the back side of the safety gate, wherein, when the distal ends of each of the pair of straps are engaged with each other in releasable locking manner on the back side of the safety gate, the cover member is maintained in tension along both the front side and back side of the safety gate by tightening the adjustable length of each of the plurality of fasteners.

2. The adjustable-width cover of claim 1 wherein the cover does not interfere with mechanical or moving portions of the safety gate.

3. The adjustable-width cover of claim 1 wherein the top edge of the cover is releasably connected to the top support rod of the safety gate.

4. The adjustable-width cover of claim 3 wherein the top edge of the cover is releasably connected to the top support rod of the safety gate using one or more of ties, straps, or buckles.

5. The adjustable-width cover of claim 1 wherein the bottom edge of the cover is releasably connected to the bottom support rod of the safety gate.

6. The adjustable-width cover of claim 5 wherein the bottom edge of the cover is releasably connected to the bottom support rod of the safety gate using one or more of ties, straps, or buckles.

7. The adjustable-width cover of claim 1 wherein, when the distal ends of each of the pair of straps are engaged with each other in releasable locking manner on the back side of the safety gate, the cover member does not fully cover the back side of the safety gate leaving a gap between each of the opposed side edges of the cover member.

8. The adjustable-width cover of claim 7 further comprising a gap member sized to cover the gap between each of the opposed side edges of the cover member.

9. The adjustable-width cover of claim 1 further comprising a motion sensor.

10. The adjustable-width cover of claim 9 wherein the motion sensor includes an audible alarm.

11. The adjustable-width cover of claim 9 wherein the motion sensor transmits a notification signal using a wireless communication protocol.

12. The adjustable-width cover of claim 9 wherein the motion sensor detects motion of the cover above a predetermined threshold.

13. The adjustable-width cover of claim 12 wherein the predetermined threshold establishes a sensitivity level of the motion sensor and wherein the sensitivity level is adjusted mechanically on the motion sensor.

14. The adjustable-width cover of claim 12 wherein the predetermined threshold establishes a sensitivity level of the motion sensor and wherein the sensitivity level is adjusted electronically using an application running on a remote computing device that communicates electronically with the motion sensor.
